(19) United States
(12) Patent Application Publication
(10) Pub. No.: US 2011/0181847 A1
(43) Pub. Date: Jul. 28, 2011

(54) PROJECTION DISPLAY DEVICE

(75) Inventors: Yusuke Yamamoto, Osaka (JP); Yuji Hashiba, Kizugawa-City (JP); Toshihiro Saruwatari, Osaka (JP)

(73) Assignee: Sanyo Electric Co., Ltd., Osaka (JP)

(21) Appl. No.: 13/013,434

(22) Filed: Jan. 25, 2011

(30) Foreign Application Priority Data
Jan. 26, 2010 (JP) 2010-014825

(51) Int. Cl. G03B 21/14

(52) U.S. Cl. 353/119

(57) ABSTRACT

A projection display device includes a projecting portion which enlarges and projects light modulated by an imager; a projection port which is formed in a main body cabinet, and passes light emitted from the projecting portion; and a cover which covers the projection port. In this arrangement, the main body cabinet is formed with a first attachment portion for attaching the cover thereon in covering the projection port, and a second attachment portion for attaching the cover detached from the first attachment portion thereon.

This application claims priority under 35 U.S.C. Section 119 of Japanese Patent Application No. 2010-14825 filed Jan. 26, 2010, entitled “PROJECTION DISPLAY DEVICE”. The disclosure of the above application is incorporated herein by reference.

### BACKGROUND OF THE INVENTION

1. Field of the Invention

The present invention relates to a projection display device for enlarging and projecting light modulated by an imager onto a projection plane.

2. Disclosure of Related Art

Conventionally, in a projector, light modulated by an imager such as a liquid crystal panel is projected onto a projection plane through a projection lens. In the projector, if the projection lens is smeared, the quality of an image is degraded. In view of this, the projection lens is covered by a lens cover when the projector is not used.

For instance, the projector may be provided with an arrangement configured to move a lens cover fixedly attached to a main body cabinet to be slidably movable, between a position of covering the projection lens and a position away from the projection lens.

In the above arrangement, however, since a mechanism for moving the lens cover is additionally provided, the structure of the projector may become complicated.

Further, since the lens cover is not needed during image projection, the user may wish to detach the lens cover from the projector in some occasions. The above arrangement, however, cannot satisfy such a demand of the user.

An arrangement may be proposed, wherein a detachable lens cover is attached to a main body cabinet. This arrangement enables to configure a projector with a relatively simplified arrangement. In this arrangement, the lens cover can be detached, when not needed.

In the case where the lens cover is configured to be detachable, however, a measure for preventing missing of the detached lens cover is required. Conventionally, there has been frequently used a method of connecting a lens cover and a main body cabinet by a string, as a method for preventing the missing.

In the above arrangement, however, since the detached lens cover is placed in the vicinity of the main body cabinet, the lens cover may obstruct an operation of the user. In particular, in the case where a projection lens having a short focal length is used, the size of the projection lens may be increased, and the size of the lens cover may be increased by an increased size of the projection lens. Thus, the lens cover may further obstruct an operation of the user.

### SUMMARY OF THE INVENTION

A projection display device according to a main aspect of the invention includes a projecting portion which enlarges and projects light modulated by an imager; a projection port which is formed in a main body cabinet, and passes light emitted from the projecting portion; and a cover which covers the projection port. In this arrangement, the main body cabinet is formed with a first attachment portion for attaching the cover thereon in covering the projection port, and a second attachment portion for attaching the cover detached from the first attachment portion thereon.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are perspective views showing an external arrangement of a projector embodying the invention.

FIGS. 2A and 2B are respectively a plan view and a bottom view showing an external arrangement of the projector as the embodiment.

FIG. 3 is a diagram showing arrangements of an optical engine and a projection lens unit in the embodiment.

FIGS. 4A and 4B are perspective views of the projector in the embodiment respectively showing a state that a lens cover is attached to a first attachment portion, and a state that the lens cover is attached to a second attachment portion.

FIG. 5 is a diagram showing an arrangement of the lens cover in the embodiment.

FIG. 6 is an elevational sectional view of essential parts showing a state that the lens cover is attached to the first attachment portion in the embodiment.

FIGS. 7A through 7D are diagrams showing an example of a method for attaching the lens cover to the first attachment portion in the embodiment.

FIGS. 8A through 8D are diagrams showing another example of the method for attaching the lens cover to the first attachment portion in the embodiment.

FIG. 9 is an elevational sectional view of essential parts showing a state that the lens cover is attached to the second attachment portion in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings.

In this embodiment, a flange portion 113 corresponds to a third surface in the claims. A front surface 12F corresponds to a first surface in the claims. An upper surface 12U corresponds to a second surface in the claims. A projection lens unit 3 corresponds to a projecting portion in the claims. A lens cover 4 corresponds to a cover in the claims. An upper plate portion 402 and a lower plate portion 403 correspond to holding portions in the claims. The description regarding the correspondence between the claims and the embodiment is merely an example, and the claims are not limited by the description of the embodiment.

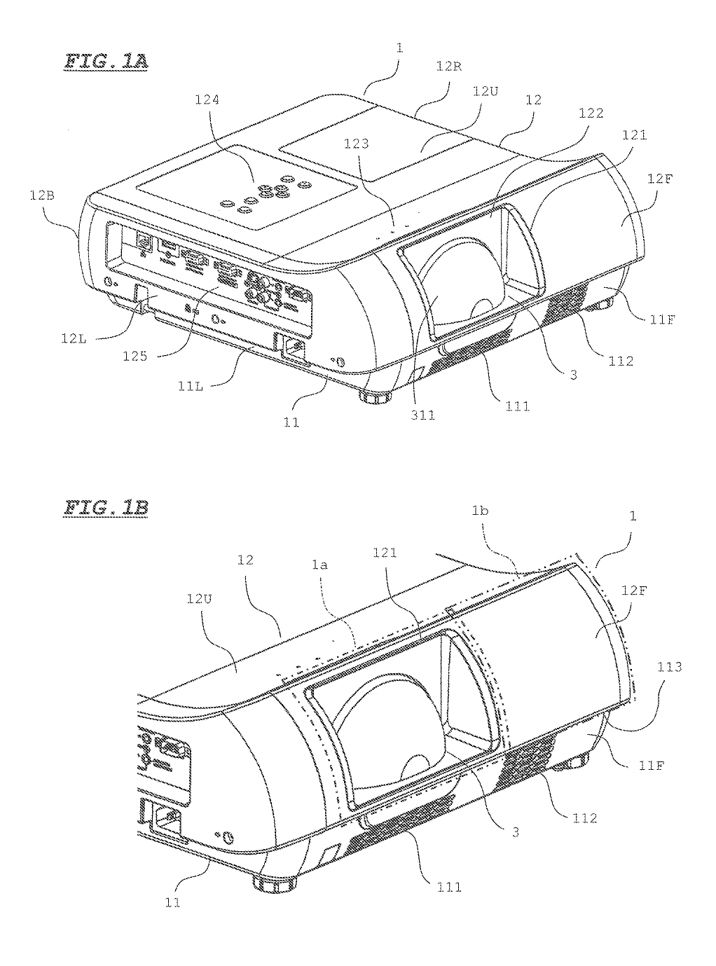

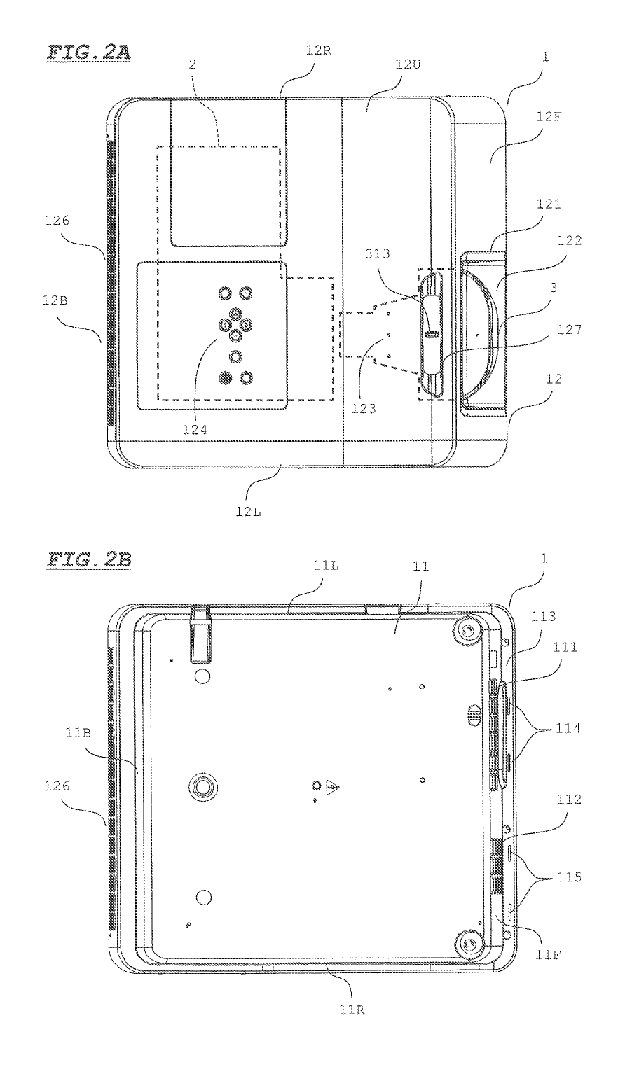

FIGS. 1A and 1B are perspective views showing an external arrangement of a projector. FIG. 1A is a perspective view of the projector showing a state that a lens cover 4 is not attached, and FIG. 18 is a perspective view enlargedly showing a front portion of the projector. Further, FIGS. 2A and 2B are respectively a plan view and a bottom view showing an external arrangement of the projector.

Referring to FIGS. 1A and 1B, and FIGS. 2A and 2B, the projector is provided with a Main body cabinet 1. The main body cabinet 1 is constituted of a lower cabinet 11, and an upper cabinet 12 to be covered onto the lower cabinet 11 from above.

The lower cabinet 11 has a box-like shape with a small height, and an upper surface thereof is opened. The lower cabinet 11 is configured in such a manner that a front surface 11F is higher than a left side surface 11L, a right side surface 11R, and a back surface 11B. The left side surface 11L and the right side surface 11R are configured in such a manner that front ends thereof gradually rise, and are continued to the front surface 11F.

The front surface 11F of the lower cabinet 11 is formed with two air inlets 111 and 112. Both of the air inlets 111 and 112 are constituted of multitudes of slit holes.

As shown in FIG. 2B, an upper end of the lower cabinet 11 is formed with a flange portion 113 over the entire periphery thereof. The flange portion 113 is adapted to receive a lower end of the upper cabinet 12 having a larger size than the size of the lower cabinet 11.

The flange portion 113 formed on the front surface 11F of the lower cabinet 11 is formed with two oblong holes 114 in an area included in a first attachment portion 1a to be described later, and is further formed with two oblong holes 115 in an area included in a second attachment portion 1b to be described later.

The upper cabinet 12 has a box-like shape, and a lower surface thereof is opened. A front portion of the upper cabinet 12 is gradually curved upward over the entirety in left and right directions, and a front surface 12F thereof is directed slightly obliquely upward. The front surface 12F of the upper cabinet 12 is gradually curved when viewed from a side direction thereof, and is protruded obliquely upward from the front surface 11F of the lower cabinet 11.

The front surface 12F of the upper cabinet 12 is formed with a rectangular projection port 121 at a position closer to the left side surface of the upper cabinet 12 with respect to the center thereof. A housing portion 122 for housing a lens 311 corresponding to a front end of a projection lens unit 3 is formed at a rear position of the projection port 121.

An upper surface 12U of the upper cabinet 12 is formed with an indicator portion 123 and an operation portion 124. A certain number of LEDs are provided on the indicator portion 123. The user is allowed to confirm whether the projector is in an operating state or a standby state by on/off states of the respective LEDs. The user is also allowed to confirm various error states. A certain number of operation keys are provided on the operation portion 124.

An AV terminal portion 125 is provided on the left side surface 12L of the upper cabinet 12, and various AV terminals are exposed on the left side surface 12L of the upper cabinet 12. AV (Audio Visual) signals are inputted and outputted to and from the projector via the AV terminal portion 125.

As shown in FIG. 2A, the back surface 12B of the upper cabinet 12 is formed with an air inlet 126. The air inlet 126 is constituted of multitudes of slit holes. The right side surface 12R of the upper cabinet 12 is formed with an unillustrated air outlet. An external air drawn into the main body cabinet 1 through the air inlet 126, and the air inlets 111 and 112 of the lower cabinet 11 is discharged through the air outlet after cooling e.g. an optical engine 2.

As shown in FIG. 2A, the optical engine 2 and the projection lens unit 3 are disposed in the main body cabinet 1.

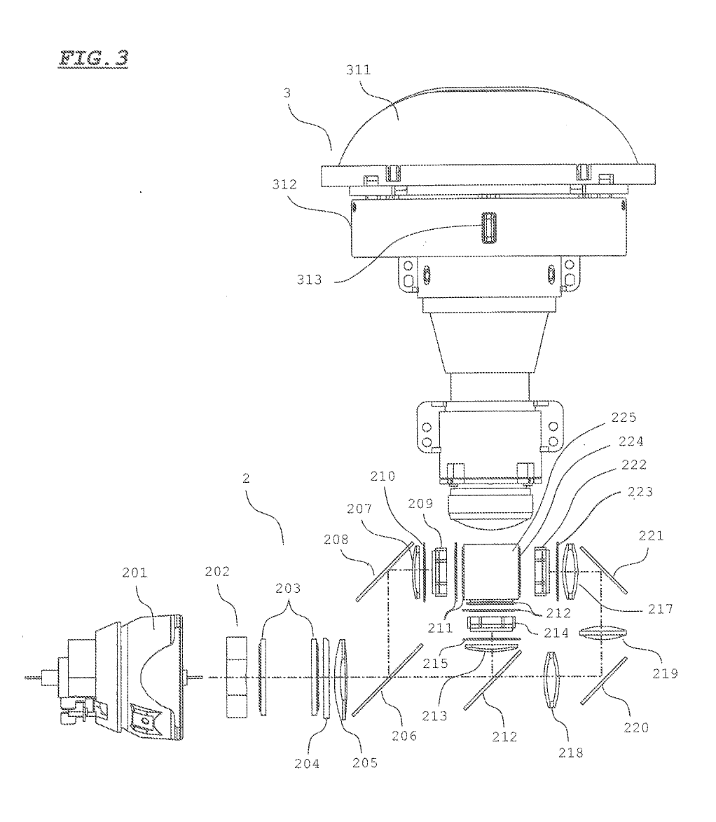

FIG. 3 is a diagram showing an arrangement of the optical engine 2 and the projection lens unit 3.

White light emitted from the light source lamp 201 is transmitted through a condenser lens 202, a fly-eye integrator 203, and a PBS array 204. The fly-eye integrator 203 is adapted to make the light amount distributions of light of the each of the colors to be irradiated onto liquid crystal panels (which will be described later) uniform, and the PBS array 204 is adapted to align polarization directions of light directed toward a dichroic mirror 206 in one direction.

Light transmitted through the PBS array 204 is transmitted through a condenser lens 205, and is entered into the dichroic mirror 206.

The dichroic mirror 206 reflects only light (hereinafter, called as “B light”) in a blue wavelength band, and transmits light (hereinafter, called as “G light”) in a green wavelength band and light (hereinafter, called as “R light”) in a red wavelength band, out of the light entered into the dichroic mirror 206.

B light reflected on the dichroic mirror 206 is irradiated onto a liquid crystal panel 209 for B light in a proper irradiation state by a lens function of the condenser lens 205 and a condenser lens 207, and reflection on a reflection mirror 208. The liquid crystal panel 209 is driven in accordance with an image signal for B light to modulate the B light depending on a driven state of the liquid crystal panel 209. One incident-side polarizer 210 is disposed on the incident side of the liquid crystal panel 209. B light is irradiated onto the liquid crystal panel 209 through the incident-side polarizer 210. Further, two output-side polarizers 211 are disposed on the output side of the liquid crystal panel 209, and B light emitted from the liquid crystal panel 209 is entered into the output-side polarizers 211.

G light and R light transmitted through the dichroic mirror 206 are entered into a dichroic mirror 212. The dichroic mirror 212 reflects the G light and transmits the R light.

G light reflected on the dichroic mirror 212 is irradiated onto a liquid crystal panel 219 for G light in a proper irradiation state by a lens function of the condenser lens 205 and a condenser lens 213. The liquid crystal panel 219 is driven in accordance with an image signal for G light to modulate the G light depending on a driven state of the liquid crystal panel 214. One incident-side polarizer 215 is disposed on the incident side of the liquid crystal panel 214, and G light is irradiated onto the liquid crystal panel 214 through the incident-side polarizer 215. Further, two output-side polarizers 216 are disposed on the output side of the liquid crystal panel 214, and G light emitted from the liquid crystal panel 214 is entered into the output-side polarizers 216.

R light transmitted through the dichroic mirror 212 is irradiated onto a liquid crystal panel 222 for R light in a proper irradiation state by a lens function of the condenser lens 205, 217, and relay lenses 218 and 219, and reflection on reflection mirrors 220 and 221. The liquid crystal panel 222 is driven in accordance with an image signal for R light to modulate the R light depending on a driven state of the liquid crystal panel 222. One incident-side polarizer 223 is disposed on the incident side of the liquid crystal panel 222, and R light is irradiated onto the liquid crystal panel 222 through the incident-side polarizer 223. Further, one output-side polarizer 224 is disposed on the output side of the liquid crystal panel 222, and R light emitted from the liquid crystal panel 222 is entered into the output-side polarizer 224.

B light, G light, and R light modulated by the liquid crystal panels 209, 214, and 222 are transmitted through the output-side polarizers 211, 216, and 224, and entered into a dichroic prism 225. The dichroic prism 225 reflects B light and R light, and transmits G light, out of the B light, the G light, and the R light, to thereby combine the B light, the G light, and the R light. Thus, image light after the color combination is projected toward the projection lens unit 3 from the dichroic prism 225.

The projection lens unit 3 is provided with a certain number of lenses, and is adapted to enlarge and project the entered image light onto a screen. The projection lens unit 3 is configured as a short focal length type, and a large sized lens 311 is included at a front end of the projection lens unit 3. Image light is emitted slightly obliquely upward from the lens 311.

The projection lens unit 3 is further provided with a focus ring 312. The focus ring 312 is formed with a focus lever 313. When the focus lever 313 is operated, the focus ring 312 is pivotally moved, and a focus lens (not shown) disposed in the projection lens unit 3 is moved in association with the focus ring 312. Thus, by operating the focus lever 313, focus for a projected image is adjusted.

As shown in FIG. 2A, the upper surface 12U of the upper cabinet 12 is formed with a transversely long opening 127 to expose the focus lever 313.

As shown in FIG. 1A, the main body cabinet 1 has a large thickness on the front portion as a whole. With this arrangement, the projection lens unit 3 having a large-sized lens can be housed in the main body cabinet 1.

As shown in FIG. 1B, a front surface of the main body cabinet 1 is formed with the first attachment portion 1a for attaching the lens cover 4 thereon. Further, the second attachment portion 1b is arranged adjacent to the first attachment portion 1a. Each of the first attachment portion 1a and the second attachment portion 1b is constituted of the front surface 12F of the upper cabinet 12, a front portion of the upper surface 12U, and the flange portion 113 formed on the front surface 11F of the lower cabinet 11. The first attachment portion 11a and the second attachment portion 11b have the same shape as each other, except that the first attachment portion 1a includes a front edge of the opening 127. As described referring to FIG. 2B, the flange portion 113 is formed with the two oblong holes 114 in the area corresponding to the first attachment portion 1a, and is formed with the two oblong holes 115 in the area corresponding to the second attachment portion 1b.

In this embodiment, the projection lens unit 3 and the projection port 121 are disposed at a position close to one side surface (left side surface) of the projector. With this arrangement, it is possible to dispose the second attachment portion 1b adjacent to the first attachment portion 1a.

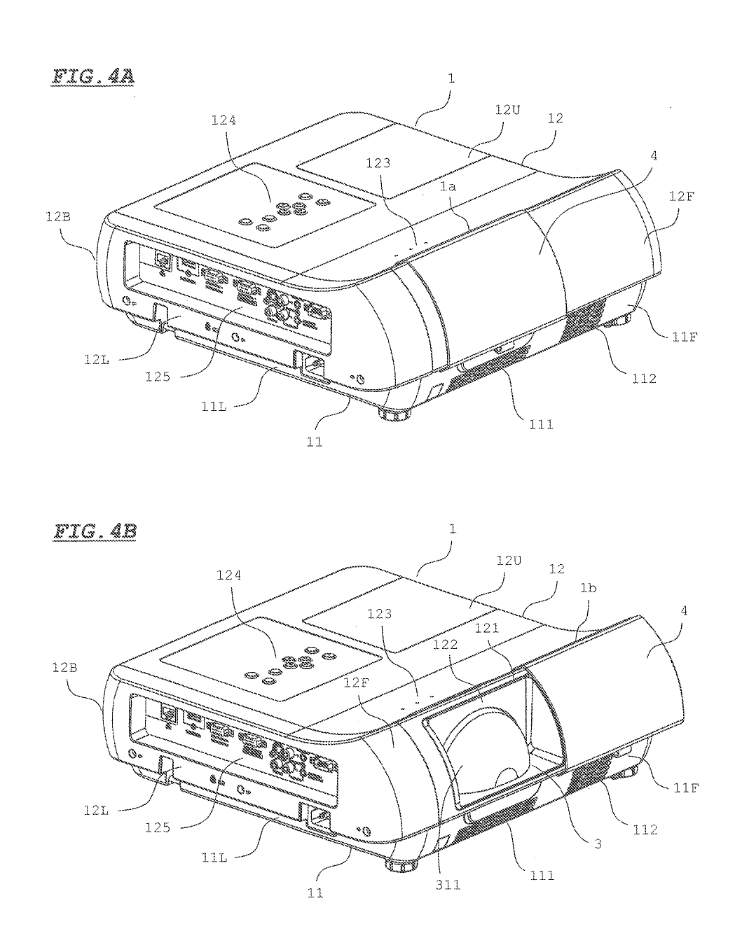

FIG. 4A is a perspective view of the projector showing a state that the lens cover 4 is attached to the first attachment portion 1a. Further, FIG. 4B is a perspective view of the projector showing a state that the lens cover 4 is attached to the second attachment portion 1b.

As shown in FIG. 4A, when the projector is not used, the lens cover 4 is attached to the first attachment portion 1a. With this operation, since the projection port 121 is covered by the lens cover 4, it is possible to prevent adhesion of dusts and fumes to the projection lens unit 3 (lens 311).

On the other hand, when the projector is used, the lens cover 4 is detached from the first attachment portion 1a. The detached lens cover 4 is attached to the second attachment portion 1b, as shown in FIG. 4B.

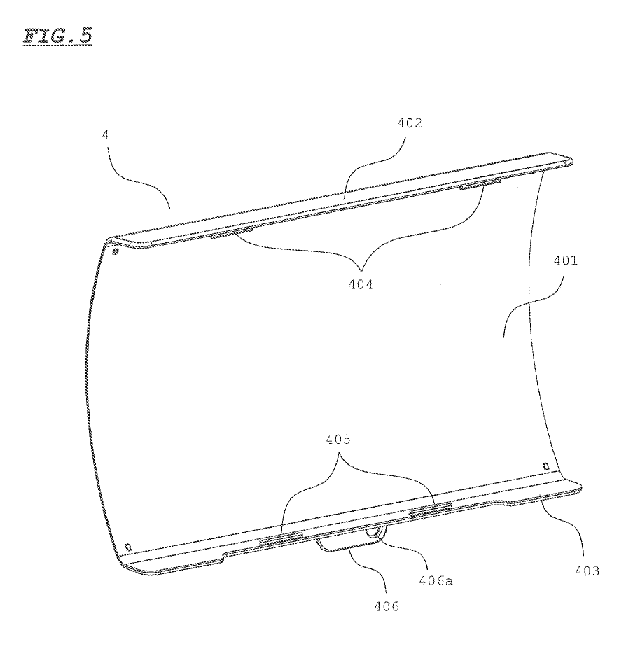

FIG. 5 is a diagram showing an arrangement of the lens cover 4. FIG. 5 is a perspective view of the lens cover 4 when viewed from the rear side thereof.

Referring to FIG. 5, the lens cover 4 is constituted of a cover main body 401, and an upper plate portion 402 and a lower plate portion 403 respectively extending rearward from an upper end and a lower end of the cover main body 401. The cover main body 401 is curved with substantially the same curvature as the front surface 12F of the upper cabinet 12, when viewed from a side direction thereof.

Two projections 404 are formed on an inner surface of the upper plate 402. Further, two projections 405 to be engaged in the oblong holes 114 and 115 formed in the main body cabinet 1 are formed on an inner surface of the lower plate portion 903.

Further, a string attachment portion 406 is formed on an outer surface of the lower plate portion 903. The string attachment portion 406 is formed with a through-hole 406a for passing a string. The user is allowed to connect the lens cover 4 and the main body cabinet 1 by a string using the string attachment portion 906, as necessary. This is further advantageous is preventing missing of the lens cover 9.

The lens cover 4 is made of a transparent resin material. Accordingly, the lens cover 4 is hardly noticeable, when being attached to the main body cabinet 1. In particular, since the lens cover 4 is hardly noticeable when being attached to the second attachment portion 1b, the above arrangement is advantageous in securing the appearance of the projector in use.

The lens cover 4 may not be necessarily transparent, as far as the lens cover 4 can protect the projection lens unit 3. If the lens cover 4 is not made transparent, the lens cover 4 may function as a light shielding shutter.

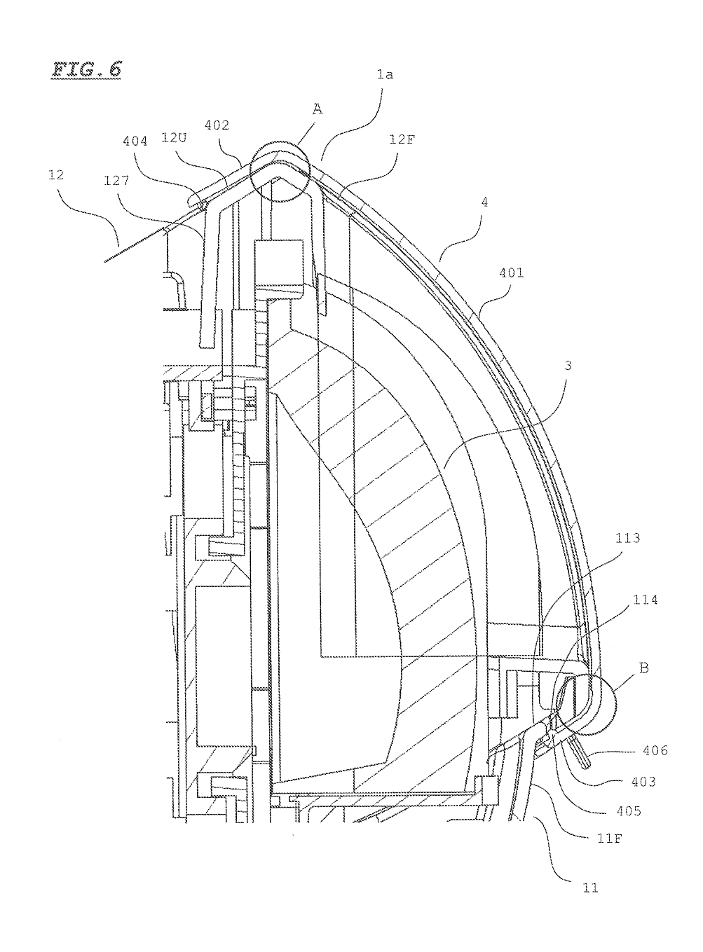

FIG. 6 is an elevational sectional view of essential parts showing a state that the lens cover 4 is attached to the first attachment portion 1a.

When the lens cover 9 is attached to the first attachment portion 1a, the upper surface 12U of the upper cabinet 12 and a lower surface of the flange portion 113 of the lower cabinet 11 are interposed between the upper plate portion 402 and the lower plate portion 403 of the lens cover 4. In this state, the two projections 404 of the upper plate portion 402 are engaged with the front edge of the opening 127, and the two projections 405 of the lower plate portion 403 are engaged in the two oblong holes 114. Further, the upper plate portion 402 and the lower plate portion 403 are brought to a slightly outwardly stretched state, as compared with a state before the lens cover 4 is attached to the first attachment portion 1a. With this operation, a fastening force in an inward direction is applied to the upper plate portion 402 and the lower plate portion 403.

In this way, the lens cover 4 is held on the first attachment portion 1a by the engagements by the upper projections 404 and the lower projections 405, and a fastening force applied from the upper plate portion 402 and the lower plate portion 403.

As shown by the portion enclosed by the circle A in FIG. 6, a corner portion defined by the upper surface 12U and the front surface 12F of the upper cabinet 12, in other words, an upper corner portion of the first attachment portion 1a is formed to have an obtuse angle. Further, a lead end of the upper corner portion is chamfered into a round shape. Similarly, as shown by the portion enclosed by the circle B in FIG. 6, a corner portion defined by the lower surface of the flange portion 113 of the lower cabinet 11 and the front surface 12F of the upper cabinet 12, in other words, a lower corner portion of the first attachment portion 1a is formed to have an obtuse angle. Further, a lead end of the lower corner portion is chamfered into a round shape.

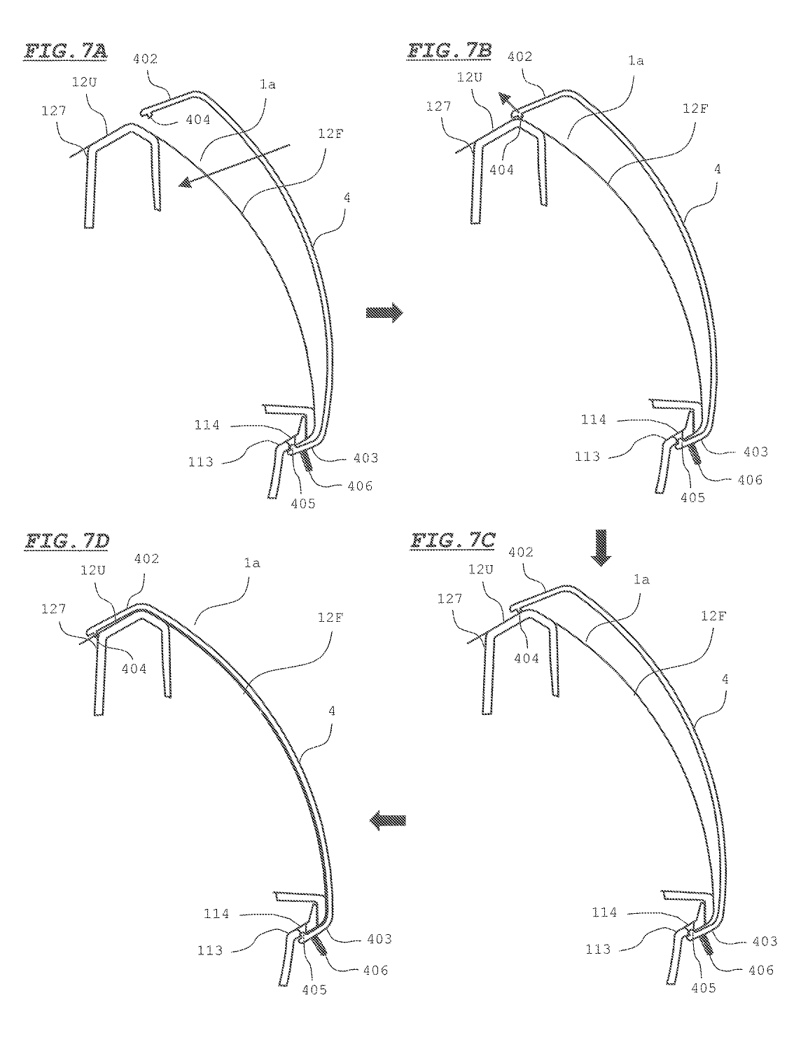

FIGS. 7A through 7D are diagrams showing an example of a method for attaching the lens cover 4 to the first attachment portion 1a.

As shown in FIG. 7A, at first, the user engages the projections 405 of the lower plate portion 403 of the lens cover 4 in the oblong holes 114 of the flange portion 113, and moves an upper portion of the lens cover 4 toward the front side of the projector, using the engagement position as a pivot point. In performing the above operation, since the inner size of the lens cover 4 is set slightly smaller than the size of the first attachment portion 1a, as shown in FIG. 7B, the upper plate portion 402 of the lens cover 4 is abutted against an upper end of the front surface 12F of the upper cabinet 12. As described above, the upper corner portion of the first attachment portion 1a has an obtuse angle and is chamfered. Accordingly, the upper plate portion 402 is easily stretched outward along the slope or the round shape of the upper end of the front surface 12F, and as shown in FIG. 7C, passes over the upper corner portion of the first attachment portion 1a. When the user pushes the upper portion of the lens cover 4 further rearward, the upper plate portion 402 is further stretched outward, and the lens cover 4 is further fitted rearward. Then, when the lens cover 4 is completely fitted on the first attachment portion 1a, as shown in FIG. 7D, the projections 404 of the upper plate portion 402 are engaged with the front edge of the opening 127.

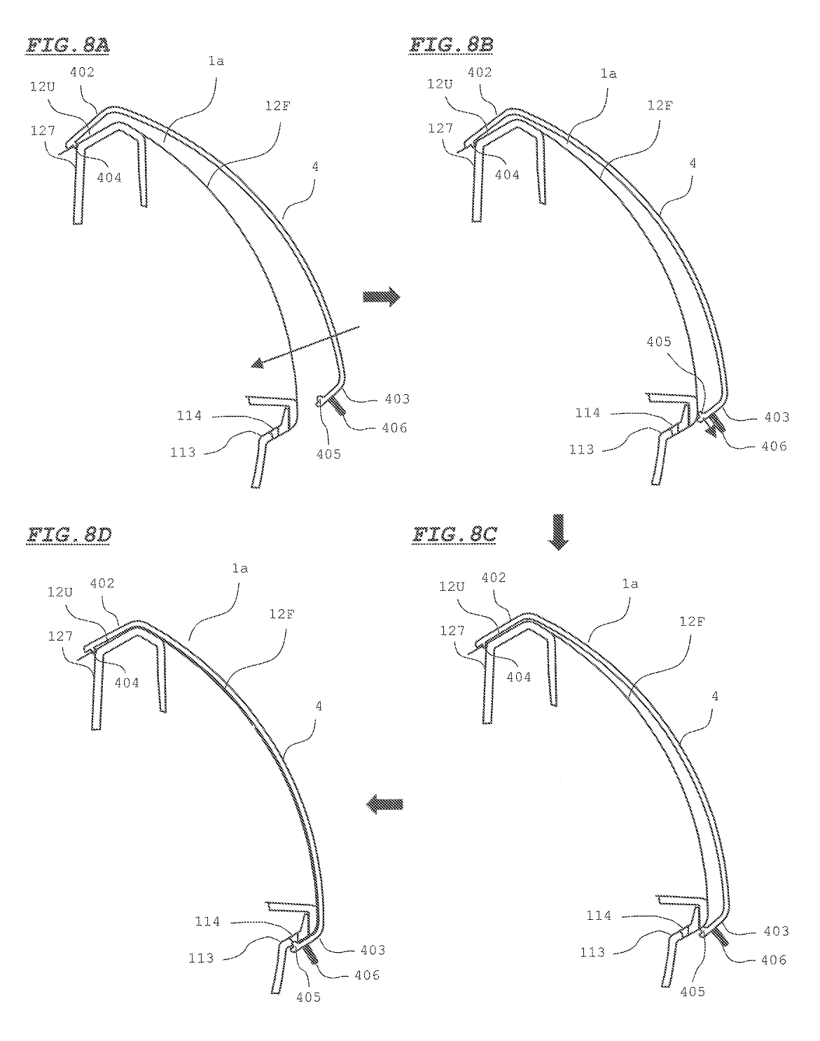

FIGS. 8A through 8D are diagrams showing another example of a method for attaching the lens cover 4 to the first attachment portion 1a.

In FIGS. 7A through 7D, the lower portion of the lens cover 4 is attached to the first attachment portion 1a before the lens cover 4 is finally attached to the first attachment portion 1a. Alternatively, as shown in FIGS. 8A through 8D, the upper portion of the lens cover 4 may be attached to the first attachment portion 1a before the lens cover 4 is finally attached to the first attachment portion 1a.

As shown in FIG. 8A, at first, the user engages the projections 409 of the upper plate portion 402 of the lens cover 4 with the front edge of the opening 127, and moves the lower portion of the lens cover 4 toward the front side of the projector, using the engagement position as a pivot point. In performing the above operation, as shown in FIG. 8B, the lower plate portion 903 of the lens cover 4 is abutted against a lower end of the front surface 12F of the upper cabinet 12. As described above, the lower corner portion of the first attachment portion 1a has an obtuse angle and is chamfered. Accordingly, the lower plate portion 403 is easily stretched outward along the slope or the round shape of the lower end of the front surface 12F, and as shown in FIG. 8C, passes over the lower corner portion of the first attachment portion 1a. When the user pushes the lower portion of the lens cover 4 further rearward, the lower plate portion 403 is further stretched outward, and the lens cover 4 is further fitted rearward. Then, when the lens cover 4 is completely fitted on the first attachment portion 1a, as shown in FIG. 8D, the projections 405 of the lower plate portion 403 are engaged in the oblong holes 114 of the flange portion 113.

The aforementioned two attachment methods are proposed as typical attachment methods. However, other attachment methods may be proposed. For instance, although the following method is less feasible as compared with the above two attachment methods, a method may be adopted, wherein both of the upper plate portion 402 and the lower plate portion 403 of the lens cover 4 are simultaneously abutted against the front surface 12F of the upper cabinet 12 to stretch both of the upper plate portion 402 and the lower plate portion 403 outward, and then, the lens cover 4 in a stretched state is fitted on the first attachment portion 1a.

In the case where the lens cover 4 is detached from the first attachment portion 1a, for instance, the steps in the reverse order of the order shown in FIGS. 8A through 8D may be used. Specifically, the user stretches the lower plate portion 403 outward, while holding the string attachment portion 406 with his or her fingers to release the engagement between the projections 405 and the oblong holes 114. Then, in this state, the user moves the lower portion of the lens cover 4 in forward direction to detach the lower plate portion 403 from the first attachment portion 1a. Thereafter, the user lifts the lens cover 4 upward to release the engagement between the projections 404 of the upper plate portion 402 and the opening 127. With this operation, the lens cover 4 is detached from the first attachment portion 1a.

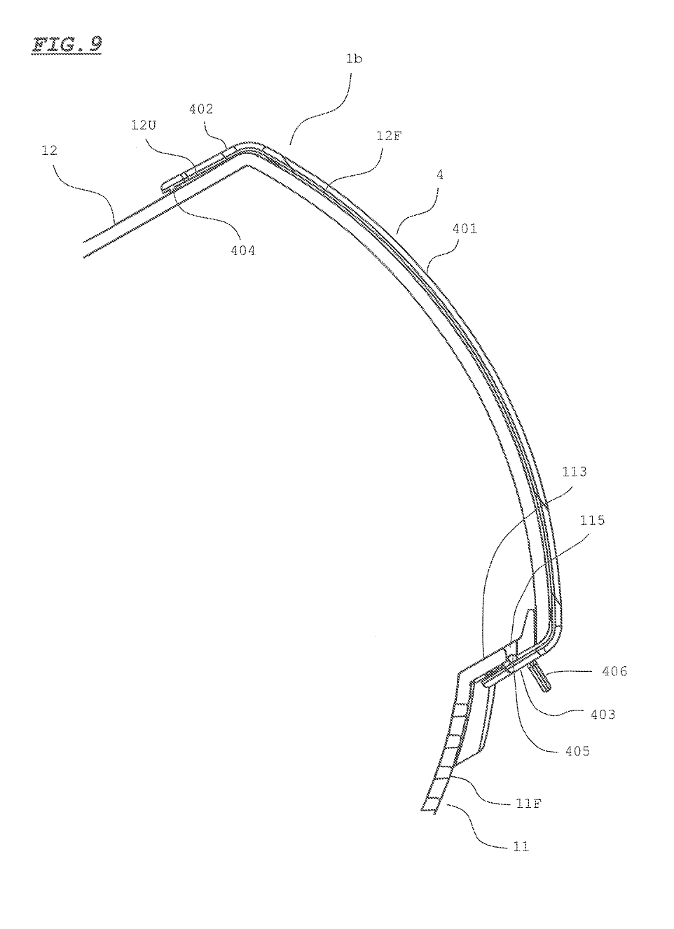

FIG. 9 is an elevational sectional view of essential parts showing a state that the lens cover 4 is attached to the second attachment portion 1b.

Since the configuration of the second attachment portion 1b is substantially the same as that of the first attachment portion 1a, a manner as to how the lens cover 4 is attached to the second attachment portion 1b is substantially the same as the manner as to how the lens cover 4 is attached to the first attachment portion 1a.

As shown in FIG. 9, when the lens cover 4 is completely fitted on the second attachment portion 1b, the projections 405 of the lower plate portion 403 are engaged in the two oblong holes 115. However, since there is no opening corresponding to the opening 127 in the second attachment portion 1b, the projections 404 of the upper plate portion 402 are abutted against the upper surface 12U of the upper cabinet 12.

Since there is no engagement by the projections 404 of the upper plate portion 402, the holding force of the lens cover 4 onto the second attachment portion 1b is weaker than the holding force on the first attachment portion 1a. However, since it is less likely that the projector may be moved when being used, there is no or less likelihood that the lens cover 4 may be inadvertently detached when being used.

Similarly to the first attachment portion 1a, an upper corner portion and a lower corner portion of the second attachment portion 1b are formed to have an obtuse angle. Further, lead ends of the upper corner portion and the lower corner portion of the second attachment portion 1b are also chamfered into a round shape.

Further, since there is no opening corresponding to the opening 127 in the second attachment portion 1b, it is desirable to attach the lens cover 4 to the second attachment portion 1b by the attachment method shown in FIGS. 7A through 7D.

As described above, in this embodiment, since the lens cover 4 in an unused state can be attached to the main body cabinet 1 i.e. to the second attachment portion 1b, it is less likely that the lens cover 4 may be missing. Further, since the lens cover 4 is attached to the main body cabinet 1, without being placed in the vicinity of the main body cabinet 1, there is no or less likelihood that the lens cover 4 may obstruct an operation of the user.

Further, in this embodiment, since the lens cover 4 is attached to the second attachment portion 1b substantially in the same manner as the lens cover 4 is attached to the first attachment portion 1a, the user can easily attach the lens cover 4 to the second attachment portion 1b.

Furthermore, in this embodiment, since the second attachment portion 1b is arranged adjacent to the first attachment portion 1a, the user can easily attach the lens cover 4 to the second attachment portion 1b.

Furthermore, in this embodiment, the lens cover 4 is attached to the first attachment portion 1a in a manner that the upper surface 12U and the flange portion 113 are interposed between the upper plate portion 402 and the lower plate portion 403. Similarly, the lens cover 4 is attached to the second attachment portion 1b in a manner that the upper surface 12U and the flange portion 113 are interposed between the upper plate portion 402 and the lower plate portion 403.

Furthermore, in this embodiment, when the lens cover 4 is attached to the first attachment portion 1a, the projections 405 of the lower plate portion 403 are engaged in the oblong holes 114. Further, when the lens cover 4 is attached to the second attachment portion 1b, the projections 405 of the lower plate portion 403 are engaged in the oblong holes 115. With this operation, the lens cover 4 is firmly held to the first attachment portion 1a or the second attachment portion 1b.

Furthermore, in this embodiment, since the upper plate portion 902 and the lower plate portion 403 are abutted against the corresponding surfaces in an outwardly stretched state, when the lens cover 4 is attached to the first attachment portion 1a or the second attachment portion 1b, as compared with a state before the lens cover 4 is attached to the first attachment portion 1a or the second attachment portion 1b, a fastening force in an inward direction is applied to the upper plate portion 402 and the lower plate portion 903. This enables to more firmly hold the lens cover 4 on the first attachment portion 1a or the second attachment portion 1b.

Furthermore, in this embodiment, the upper corner portion and the lower corner portion of the first attachment portion 1a have an obtuse angle, and the upper corner portion and the lower corner portion of the second attachment portion 1b have an obtuse angle. With this arrangement, in attaching the lens cover 4 to the first attachment portion 1a or the second attachment portion 1b, the upper plate portion 402 and the lower plate portion 403 are easily stretched outward, even if the upper plate portion 902 of the lens cover 4 is abutted against the upper end of the front surface 12F of the upper cabinet 12, or the lower plate portion 403 is abutted against the lower end of the front surface 12F. Accordingly, the lens cover 4 can be smoothly fitted on the first attachment portion 1a or the second attachment portion 1b.

The upper corner portion and the lower corner portion of the first attachment portion 1a are chamfered, and the upper corner portion and the lower corner portion of the second attachment portion 1b are chamfered. With this arrangement, the lens cover 4 can be smoothly attached to the first attachment portion 1a or the second attachment portion 1b.

Furthermore, in this embodiment, the first attachment portion 1a and the second attachment portion 1b are configured to be directed obliquely upward. In other words, the upper surface 12U of the upper cabinet 12 and the lower surface of the flange portion 113 of the lower cabinet 11 have an upward slope toward the front surface 12F of the upper cabinet 12. With this arrangement, a gravitational force in the attaching direction is acted on the lens cover 4 attached to the first attachment portion 1a or the second attachment portion 1b. Thus, there is no or less likelihood that the lens cover 4 may be detached from the first attachment portion 1a or the second attachment portion 1b.

Furthermore, in this embodiment, engagement of the first attachment portion 1a with the projections 404 of the lens cover 4 is made by using the opening 127 for exposing the focus lever 313 outward. The above arrangement eliminates the need of forming a hole or a like member in the upper surface of the main body cabinet 1 for engagement, and prevents deterioration of the appearance of the projector.

The embodiment of the invention has been described as above. The invention, however, is not limited to the foregoing embodiment, and the embodiment of the invention may be modified in various ways other than the above.

For instance, in this embodiment, the front surface 12F of the upper cabinet 12, in other words, front surfaces of the first attachment portion 1a and the second attachment portion 1b are configured to be directed obliquely upward. Alternatively, the front surfaces of the first attachment portion 1a and the second attachment portion 1b may be configured to be directed in a horizontal direction.

Further, in this embodiment, the projections 905 are formed on the lower plate portion 403 of the lens cover 4, and the oblong holes 114 and 115 are formed in the main body cabinet 1 (flange portion 113). Conversely, projections may be formed on the main body cabinet 1 (flange portion 113), and holes to be engaged with the projections may be formed in the lower plate portion 903 of the lens cover 4. Further alternatively, the projections may be engaged in recesses, in place of the holes. Further alternatively, an engagement structure other than the projections and the holes (recesses) may be used.

In the case where the aforementioned engagement structure is used, it is desirable to provide the engagement structure between at least one of the upper plate portion 402 and the lower plate portion 403, and a surface of the main body cabinet 1 opposing thereto.

In the embodiment, both of the upper corner portion and the lower corner portion of each of the first attachment portion 1a and the second attachment portion 1b are formed to have an obtuse angle. Alternatively, either one of the upper corner portion and the lower corner portion of each of the first attachment portion 1a and the second attachment portion 1b may be formed to have an obtuse angle. In the modification, an attachment method of abutting the lens cover 4 against the corner portion having an obtuse angle may be used. Since the attachment method shown in FIGS. 7A through 7D is desirable in attaching the lens cover 4 to the second attachment portion 1b, it is desirable to form the upper corner portion of the second attachment portion 1b to have an obtuse angle. In the embodiment, a chamfering process is applied to form a round shape. The chamfering process may not be necessarily required.

The embodiment of the invention may be changed or modified in various ways as necessary, as far as such changes and modifications do not depart from the scope of the claims of the invention hereinafter defined.

What is claimed is:

1. A projection display device comprising:
a projecting portion which enlarges and projects light modulated by an imager;
a projection port which is formed in a main body cabinet, and passes light emitted from the projecting portion; and
a cover which covers the projection port, wherein
the main body cabinet is formed with a first attachment portion for attaching the cover thereon in covering the projection port, and a second attachment portion for attaching the cover detached from the first attachment portion thereon.

2. The projection display device according to claim 1, wherein
both of the first attachment portion and the second attachment portion are configured such that the cover is engaged with respect to an outer portion of the corresponding attachment portion.

3. The projection display device according to claim 1, wherein
the second attachment portion is arranged adjacent to the first attachment portion.

4. The projection display device according to claim 1, wherein
the cover includes a cover main body which covers the projection port, and a pair of holding portions which are formed on both ends of the cover main body and interpose the first attachment portion and the second attachment portion therebetween, and
each of the first attachment portion and the second attachment portion has a first surface opposing to the cover main body, and a second surface and a third surface each opposing to the holding portions.

5. The projection display device according to claim 4, wherein
each of the first attachment portion and the second attachment portion is configured in such a manner that at least one of a corner portion defined by the first surface and the second surface and a corner portion defined by the first surface and the third surface has an obtuse angle.

6. The projection display device according to claim 1, wherein
each of the first attachment portion and the second attachment portion is directed obliquely upward.
